(19) United States
(12) Patent Application Publication
(10) Pub. No.: US 2015/0058046 A1
(43) Pub. Date: Feb. 26, 2015

(54) INSURANCE CLAIM OWNERSHIP AND ASSIGNMENT SYSTEM

(71) Applicants: Marc-Olivier Huynh, Montreal (CA); Guillaume Leonard, Montreal (CA); Benoit Desmeules, Laval (CA); Craig Batten, Kitchener (CA); Pascal Begin, Saint-Charles-Borromee (CA)

(72) Inventors: Marc-Olivier Huynh, Montreal (CA); Guillaume Leonard, Montreal (CA); Benoit Desmeules, Laval (CA); Craig Batten, Kitchener (CA); Pascal Begin, Saint-Charles-Borromee (CA)

(73) Assignee: Symbility Solutions Inc., Toronto (CA)

(21) Appl. No.: 14/464,784

(22) Filed: Aug. 21, 2014

Related U.S. Application Data
(60) Provisional application No. 61/869,037, filed on Aug. 22, 2013.

(51) Int. Cl. G06Q 40/08

(52) U.S. Cl. CPC G06Q 40/08
USPC 705/4

(57) ABSTRACT

An insurance claim handling system facilitates preparation of an insurance claim. In one implementation, the system facilitates multiple participants owning an insurance claim file, allowing the multiple participants to concurrently modify portions of the insurance claim file. In one implementation, the system facilitates the assignment of multiple tasks to different participants of a single vendor and/or automatically generates task assignments.

### CROSS-REFERENCE TO RELATED PATENT APPLICATIONS

The present application claims priority under 35 USC 120 from co-pending US Provisional Patent Application Ser. No. 61/869,037 filed on Aug. 22, 2013 by Huynh et al. and entitled INSURANCE CLAIM OWNERSHIP AND ASSIGNMENT SYSTEM, the full disclosure of which is hereby incorporated by reference.

### BACKGROUND

Insurance claims frequently involve multiple participants/vendors and multiple estimates as well as multiple remedial actions. The tracking of such claims, scheduling of claim assignments and collaboration between multiple vendors is presently very difficult.

### BRIEF DESCRIPTION OF THE DRAWINGS

FIG. 1 is a schematic diagram of an example insurance claim ownership and assignment system.

FIG. 2 is a diagram of an example screen display illustrating an example ownership designation.

FIG. 3 is a flow diagram of an example method regarding ownership of insurance claim file components and access to such components.

FIG. 4 is a schematic diagram of a portion of a memory of the system of FIG. 1 comprising a component and a copy of the component after being modified.

FIG. 5 is a flow diagram of an example method regarding the assignment of tasks.

FIG. 6 is a diagram of an example display screen illustrating a general tab of an assignment page.

FIG. 7 is a diagram of another example display screen illustrating a participants tab of the assignment page of FIG. 6.

FIG. 8 is a diagram of another example display screen illustrating the participants tab and further illustrating multiple assignments.

FIG. 9 is a diagram of another example display screen illustrating an example estimates tab of the assignment page of FIG. 6.

### DETAILED DESCRIPTION OF EXAMPLES

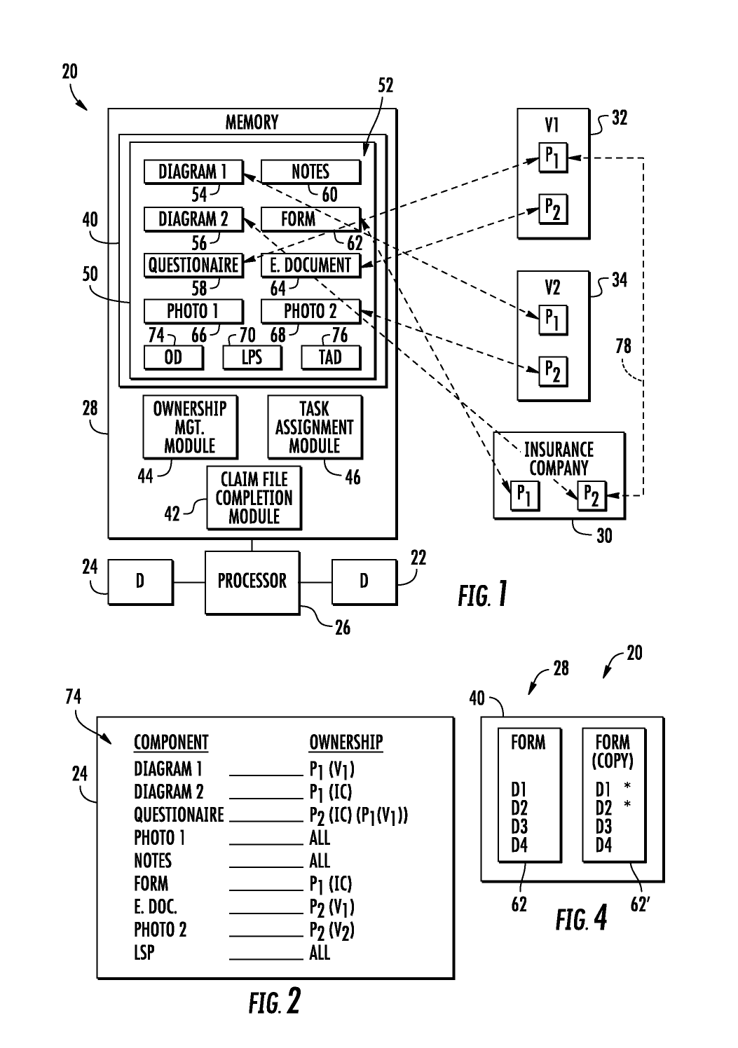

FIG. 1 schematically illustrates an example insurance claim handling system 20. Insurance claim handling system 20 facilitates the preparation and completion of an insurance claim. Insurance claim handling system 20 allows multiple participants within a company and/or outside the company to concurrently work on an modify an insurance claim. Insurance claim handling system 20 further facilitates the assignment of insurance claim tasks two different participants of the same vendor. In one implementation, insurance claim handling system 20 display such assignments allowing such assignments to be seen by all vendors. In one implementation, insurance claim handling system 20 automatically generates or creates task assignments. As a result, insurance claim and system 20 enhances tracking of insurance claims, scheduling of claim task assignments and collaboration between multiple participants and multiple vendors.

In one implementation, system 20 is a web based application (server) and an internet connection is required to access system 20. System 20, sometimes referred to as claims connect, is the communications hub, workflow engine and application where all the data resides. System 20 facilitates the creation, modification and completion of claim files using multiple remotely located data input devices, such as remotely located computers and portable electronic devices. In one implementation, such mobile devices have installed thereon a mobile claims application which may receive data or changes while disconnected from the Internet and while disconnected from system 20. In one implementation, participants gather information using the mobile claims application in the field and upload (synchronizes) that data to system 20 which aggregates such data and changes. In the example illustrated, diagrams and estimates are created using the mobile claims application on the remote computing device. In such an implementation, system 20 does not create diagrams and has limited capabilities when it comes to editing an estimate. In such an implementation, system 20 facilitates reviews and approval of an insurance claim file.

Insurance claim handling system 20 comprises transceiver 22, display 24, processor 26 and memory 28. Transceiver 22 comprises one or more devices by which system 20 communicates to various participants such as different participants within an insurance company 30 or external participants such as participants of vendors 32, 34. In one implementation, transceiver 22 comprises a device of select communication through a local area network and/or a wide area network (such as the Internet) in a wired or wireless fashion.

Display 24 comprise a screen, monitor, display panel or the like by which data, instructions, commands, prompts and other information is presented to one or more participants. Display 24 may comprise the display screen of a terminal or monitor at insurance company 30 or a terminal or monitor at one or both of vendors 32, 34. Display 24 may comprise a display screen of a portable electronic device, such as a tablet computer, smart phone or the like. Display 24 facilitates the presentation of information regarding ownership status and task assignment status to the various participants utilizing system 20.

Processor 26 comprises one or more processing units carry out instructions contained in memory 28. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, memory 28 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 28 comprises a non-transitory computer-readable medium configured to be read by processor 26. In one implementation, an entirety of memory 28 is locally located with respect to processor 26. In another implementation, memory 28 is distributed. For example, in one implementation, portions of memory 28, such as data, are remotely located with respect to processor 26, wherein processor 26 accesses memory 28 across a local area network or a wide area network in a wired or wireless fashion. For example, one implementation, data from portions of memory 28 is accessed via a remote server computer.

Memory 28 comprises database portion 40, claim file completion module 42, ownership management module 44 and task assignment module 46. Database portion 40 comprises a record or database of multiple insurance claim files, such as the example insurance claim file 50 schematically illustrated. In one implementation, each insurance claim file 50 comprise a file for a property insurance claim. In another implementation, insurance claim file 50 comprises a file for a medical or health insurance claim. For purposes of this disclosure, the term “file” when referring to an insurance claim file encompasses a collective number of files, documents or the like pertaining to an individual claim. As shown by FIG. 1, each insurance claim file 50 comprises multiple elements, parts, portions, items or components 52 that make up the claim file. In the example illustrated, components 52 comprises diagrams 54, 56, questionnaire 58, notes 60, form 62, external document before, photos 66, 68 and loss summary page 70. In other implementations, insurance claim file 50 comprise a greater or fewer of such components. In other implementations, insurance claim file 50 comprises other types of documents or data formats. Each of such components 52 may have been imported into file 50 or may have been completed while as part of file 50.

Claim file completion module 42 comprises code, instructions or program logic stored in memory 28 and configured to direct processor 26 in the display of information, the presentation of information requests, prompts and the receipt of information, commands and the like to facilitate completion of an insurance claim embodied as insurance claim file 50. For purposes of this disclosure, the phrase “configured to” denotes an actual state of configuration that fundamentally ties the stated function/use to the physical characteristics of the feature proceeding the phrase “configured to”. Claim file completion model 42 cooperates with ownership management module and task assignment module 46 to facilitate the completion of tasks of the insurance claim.

Ownership management module 44 comprises code, instructions or program logic stored in memory 28 and configured to direct processor 26 in the oversight and monitoring of access to individual components 52 of the insurance claim file 50. Ownership management module 44 facilitates concurrent viewing and concurrent modifications to one or more of the various components 52 to enhance collaboration while minimizing data entry conflict. Ownership management module 44 maintains ownership designations 74 stored in memory 28.

Ownership designations 74 link, associate or designate those participants who have ownership rights in each of the individual components 52 of insurance claim file 50. When an individual component 52 is initially created or completion of the component, such as a form, is initiated, ownership matter module 44 initially designates ownership of the particular component to the originator or person craning our initiating completion of the component 52. In one implementation, ownership of an individual component 52 allows the owner to modify aspects of the individual component 52. In such an implementation, ownership is not required to view components 52. As indicated by broken arrow lines, various components 52 of insurance claim file 50 are currently owned by different participants. When a component 52 of insurance claim file 50 is owned, it is updated every synchronization with changes from other participants/users.

FIG. 2 illustrates an example display of ownership designations 74 on display 24. As shown by FIG. 2, diagram 54 is currently owned to participant 1 of vendor 32. Diagram 56 is currently owned by participant 1 of insurance company 30. Questionnaire currently owned by participant 2 of insurance company 30. As indicated by the second parenthetical in 2, the questionnaire 58 was previously owned by participant one of vendor 32, but was assigned as indicated by broken arrow line 78 in FIG. 1. Photo 66 and notes 60 have been assigned or released to all participants, allowing any participant to markup or modify such components 52. Form 62 is presently owned by participant 2 of vendor 34.

Loss summary page 70, which comprises summary of the insurance claim information, the also designated as being owned by all participants. In the example illustrated, loss summary page is automatically designated as being owned by all participants or users who have ownership of at least one component 52. As a result, multiple users may modify loss summary page 70 at the same time. Ownership management module 44 merges changes to the loss summary page from multiple sources. For example, if participant A modified the address and participant B modified the coverage details, the module needs to take both changes and merge them together. Without such merging, participant B could otherwise override changes that participant A has done at the same time. In the example illustrated, ownership management module 44 automatic resolves changes to the loss summary page at the time when the claim is uploaded. As a result, all claim participants benefit from having visibility into all the updates made to a claim file. For example if the loss address is initially incorrect, other participants save time by receiving the corrected address in their claim file.

In one implementation, special access or modification rules are applied to deductibles and coverages to avoid conflicts/inconsistencies. For example, if user A removes a coverage while user B is adding items with that coverage, this will cause data corruption. If user A changes the flat deductible, and it's used in the user B's estimate, there could also be inconsistencies if things are not recalculated at appropriate times. To avoid inconsistencies, the following rules are applied by ownership management module 44. In one implementation, such rules are applied based upon whether changes are being made while the participant making such changes is directly connected to system 20. For example, in one of limitation, a participant may make changes to components 52 of claim file 50 or enter information towards the completion of claim file 50 by utilizing a mobile claims application installed on a remote computer or a portable electronic device (smart phone, tablet computer, laptop computer). In certain circumstances, changes are made or information is gathered while the mobile claims application is not in communication with system 20, which comprises a web-based or server-based application for the remote mobile claims application. In such circumstances, the mobile claims application is subsequently synced with system 20, wherein the changes in gathered information or uploaded to system 20. In other circumstances, the mobile claims application is directly connected to system 20 while changes to claim file 50 are being made or while information is being entered for the completion of claims file 50 at system 20.

When not directly connected to system 20, users are not be able to remove coverages—users can add new coverages and edit deductible, limits, etc. . . . and change the coverage type. When directly connected to system 20, users are not be able to remove coverages *unless* no one has ownership of the claim. When a claim is uploaded to memory 28, ownership management of 44 checks if the flat deductible was changed or if “use flat deductible” was changed or if a coverage deductible or limit (don't check reserve) was changed and if yes, claim file completion module 42 recalculates the existing estimates. When the mobile claims application synchronizes updates to the loss summary page for each claim, the mobile claims application checks if the flat deductible was changed or if “use flat deductible” was changed or if a coverage deductible or limit (don't check reserve) was changed and if yes, the mobile claims application recalculates the existing estimates.

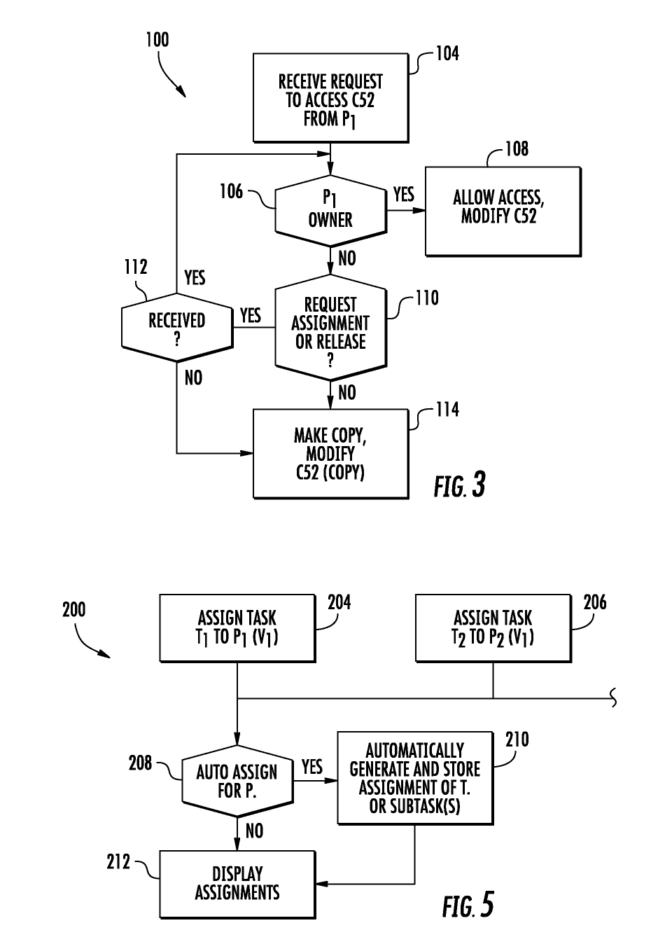

FIG. 3 is a flow diagram of one example method 100 that may be carried out by ownership management module 44 of system 20 using such ownership designations. As indicated by block 104, system 20 receives a request to access and modify an individual component 52 from a first user/participant. In one implementation, the requested routed to ownership management module 44 by claim file completion module 42 which interfaces with participants working on insurance claim file 50.

As indicated by block 106, ownership management module 44 directs processor 26 to consult ownership designations 74 to determine whether or not the participant making the request for axis to the one or more components 52 has ownership of each of the one or more components 52. As indicated by block 108, if the participant/user make the request does have ownership, ownership module 44 directs processor 26 to allow the participant axis to the one or more owned components 52 so as to modify the one or more components 52. At the same time, ownership module 44 may also be allowing other participants to access and modify other of components 52 based upon their ownership of the other components 52 as stored in ownership designations 74.

As indicated by block 110, in circumstances where the participant/user make the request to access and modify the particular component 52 is not listed or identified as an owner of the particular component 52 in ownership designations 54, ownership management module 44 directs processor 26 to prompt the participant/user, on display 24, for input regarding whether he or she wishes to request an assignment or release from the current owner of the particular component 52. An assignment of ownership transfers ownership from the current owner to the participant/user making the request. A release of ownership results in the particular component 52 being “unowned”, Vail for modification to any participant. In one implementation, a release may be the designated for a particular participant for a particular time, wherein ownership reverts back to the owner after the particular time. If the participant/user indicates that he or she would like to request an assignment or release, ownership management of 44 directs processor 26 to communicate with the current owner making the request.

As indicated by block 112, if the owner of the particular component 52 agrees to assigning or releasing the particular component 52 to the participant/user making the request, ownership is transferred or released and output designations 74 are updated by ownership management module 44. Method 100 then returns to block 106, wherein the prison/user would be identified as the owner in block 106 and provided with authorization or axis to modify the particular component 52 per block 108.

As indicated by block 114, if the participant/user making the request in block 104 does not wish to request that the current owner assign or release ownership rights or if the current owner refuses to release or assign ownership rights, ownership management module 44 directs processor 26 to notify, via display 24, the participant that a changes must be made to a copy of the owned component. Thereafter, ownership management of 44 and claim file completion model 42 allow the participant requesting the modification in block 104 to modify the copy of the particular insurance claim file component 52.

FIG. 4 illustrates one implementation of database portion 50 of memory 28 comprising component 62 and the copy 62′ of component 62. The example illustrated, both the previously owned component 62 and the modified copy, component 62′ are starred in memory 28. In the example illustrated, claim file completion module 42 directs processor 26 to either track changes being made in the copy 62′ or to compare copy 62′ with the original 62, wherein the differences and/or similarities/commonalties between component 62 and copy 62′ are stored with such components and/or are presented when being displayed on display 24. In the example illustrated, those unchanged portions of copy 62′ are identified with asterisks come indicating that data portions D3 and D4 in the copy 62′ having changed or are different from the original form 62 owned by the first participant of the insurance company.

In one implementation, upon completion of the changes, ownership management module 44 notifies the current owner of the existence of the copy 62′ and asks the current owner as to whether he or she is willing to replace or overwrite form 62 with the copy 62′. Regardless of whether the owner proceeds with replacing or overwriting form 62 with copy 62′, copy 62′ remains and is designated as being owned by the participant/user who made the request in block 104 and who made the modifications to the original form 62. In yet another implementation, if the current owner agrees to overwriting or replacing form 62 with copy 62′, copy 62′ is deleted.

Referring back to FIG. 1, task assignment module 46 comprises code, instructions or program logic stored in memory 28 and configured to direct processor 26 in the delegation or assignment of activities, projects or tasks towards the completion of insurance claim file 50. Examples of such tasks include, but are not limited to, contacting an insured, scheduling and inspection, performing an inspection, completing an estimate, proving an estimate, scheduling a job, starting a job, and completing a job. A job may be the repair, mitigation and/or replacement of a structure. Task assignment module 46 facilitates the assignment of tasks to different participants at a single vendor. Task assignment module 46 further facilitates the display of task assignments, allowing selected participants or allowing all participants, such as all vendors, to view task assignments, task statuses and the like.

In one implementation, task assignment module 46, in response to receiving a first assignment of a first task to a first assignee, automatically generates and stores in memory 58 a second assignment of the first task or one or more sub-tasks related to the first task to one or more second assignees. As a result, task assignment is made more efficient. In one implementation, the generation of a task assignment or receipt of a task assignment causes tests same module 46 to direct processor 26 two automatically notify the assignee/recipient of the task of the assignment. In one implementation, such notification is made by a message transmitted across a local area network are a wide area network to the recipient in a wired or wireless fashion.

FIG. 5 is a flow diagram illustrating an example method 200 that may be carried out by task assignment module 46. As indicated by block 204, in response to receiving a request via an input, such as in one embodiment in which display 24 comprise a touch screen, task assignment module 46 directs processor 26 to assign the task T1 to participant P1 of vendor 32. Examples of participants/assignment requesters that may assign a task internally or externally include, but not limited to, insurance companies and/or intermediaries such as a claim management company, independent adjuster or contractor network. Examples of types of tasks that may be assigned, include, but are not limited to, mitigation, expert opinion, emergency repair, damaged property removal, reinspection and the like. In one implementation, the task assignment is recorded as part of task assignment designation 76 (shown in FIG. 1) in memory 28. Task assignment designation 76 comprises a file or record of ongoing and prior task assignments to different participants/vendors.

As indicated by block 206, in response to receiving a request via an input, task assignment module 46 directs processor 26 to assign the task T2 to participant P2 of the same vendor, vendor 32. In one implementation, this task assignment is recorded as part of task assignment designation 76 (shown in FIG. 1) in memory 28. Below is an example scenario of the assignment of insurance claim task and its reassignment to two contractors by an intermediary.
1—Claim is created by the InsCo
2—Claim is assigned for mitigation to the intermediary
3—Claim is assigned for reconstruction to the intermediary
4—Intermediary reassigned the reconstruction—roofing to contractor A
5—Intermediary reassigned the reconstruction—flooring to contractor B
6—Contractor A change reconstruction—roofing assignment status to completed
7—Intermediary is automatically notified and their reconstruction—roofing assignment status is automatically updated to completed
8—Nothing new for the InsCo
9—Contractor B change reconstruction—flooring assignment status to completed
10—Intermediary is automatically notified and their reconstruction—flooring assignment status is also automatically updated to completed
11—InsCo is automatically notified and their reconstruction assignment status is automatically updated to completed

As indicated by block 208, for each received task assignment, task assignment module 46 determines whether the task assignment will result in an automatic generation of a subsequent assignment. In one implementation, task assignment module 46 consults predefined settings, such as in a data table, stored in task assignment designation file 76, wherein the criteria that trigger the automatic generation of task assignments are stored. In one implementation, the criteria for triggering the automatic generation of task assignments by task assignment module 46 comprises the particular participant and/or the particular company or vendor to which the task was assigned. Companies or participants have the option to define a list of Internal Assignment types with either an internal assignee or a user group that would be triggered every time a claim task is assigned internally. For example, upon a particular participant identified in the task assignment designation table 76, task assignment module 46 is directed to automatically generate an assignment of the same task or one or more subtasks to one or more other participants, such as persons operating under the supervision of the original recipient of the assignment that triggered the automatic assignment generation. In one implementation, the criteria for triggering the automatic generation of task assignments by task assignment module 46 comprises the particular assignor of the task. In another implementation, the criteria for triggering the automatic generation of task assignments by task assignment module 46 comprises one or more characteristics of the task being assigned. In one implementation, criteria for triggering the automatic generation of assignments or sub-assignments may comprise a time period. For example, during a certain window of time, testify module 46 may be directed to generate automatic assignments. In some implementations, the criteria for triggering the automatic generation of assignments or some assignments comprises multiple criteria such as what participant received the original of triggering assignment, from what assignee the assignment was made, characteristics of the task being assigned, such as the type of task, and/or a predefined period of time.

The following is an example task assignment triggers causing assignments to be automatically generated by task assignment module 46:
1. Assignment type of Flooring is defined. Whenever this assignment type is used, in addition the vendor assigned the claim the flooring Vendor Coordination Internal assignment type and the Coordinator is assigned.
2. Supervisor: Assignment type of Adjusting is defined. When this assignment type is the Supervisor for the assigned user is looked up (User Groups) and is assigned. For this to work well, we would need to improve on how the User groups work.
   Note this could potentially cascade. Claim assignment is made—secondary assignment is triggered—secondary assignment triggers a third.

As indicated by block 210, if the assignment of a task to a particular participant triggers an automatic generation of an assignment, task assignment module 46 automatically generates and stores the assignment of the task and/or subtasks. As indicated by block 212, each of the task assignment module 46 further directs processor 26 to display each of the task assignments when requested by participant or other requester. In one implementation, certain task assignments are not viewable or are hidden with respect to certain participants are certain users. In one implementation, assignments of particular types of tasks remain hidden when the display of assignments is made. In one implementation, the tasks are identified, but the recipients of such tasks are not identified for at least some of the recipients. In yet another implementation, the status of various assignments are hidden from certain participants. In one implementation, the following policies regarding the display ability to view or axis assignment statuses are applied by task assignment module 46:

Assignment Sent—cannot hide

Assignment Received—cannot hide

Insured Contacted

Inspection Scheduled

Inspection Performed

Estimate Completed

Estimate Approved

Assignment Completed—cannot hide

In one implementation, the assignment of a task is not completed until the task recipient accepts the assignment. In one implementation, the requested assignment of a task to recipient is transmitted to the recipient or the employer of the recipient. Upon receiving a response accepting the assignment, task assignment designations 36 is updated with the new assignment. In one implementation, acceptance of the task assignment by the recipient must be received before the automatic task assignment generation is carried out in steps 208 and 210.

In one implementation, task assignment module 46 assigns tasks or carries out the requested assignment of tasks according to the following rules:
1. A claim can be assigned multiple times to the same vendor or the same internal user
   i. This means that the list of vendors and internal users (and peers to be consistent) should not be filtered based on who's already assigned to the claim
2. The same assignment type can be reused multiple times in a claim (ex: insurance company assigns contractor A for mitigation work and also assigns contractor B for mitigation work)
3. If a claim task is assigned to a vendor, the assignor can also decide to assign internal users to that same assignment
4. If the assignee is an intermediary, it can decide to sub-assign the claim to one of its branches/vendors—it will have to pick an assignment type from its own list when doing the assignment
5. The originator can add participants (users or peers) to the claim in general or to a specific assignment
6. An assignee can only add participants (users or peers) to a specific assignment (not the claim in general)
7. When a claim task is assigned to a vendor, the appropriate estimates need to be created, but the estimates need to be linked to that assignment

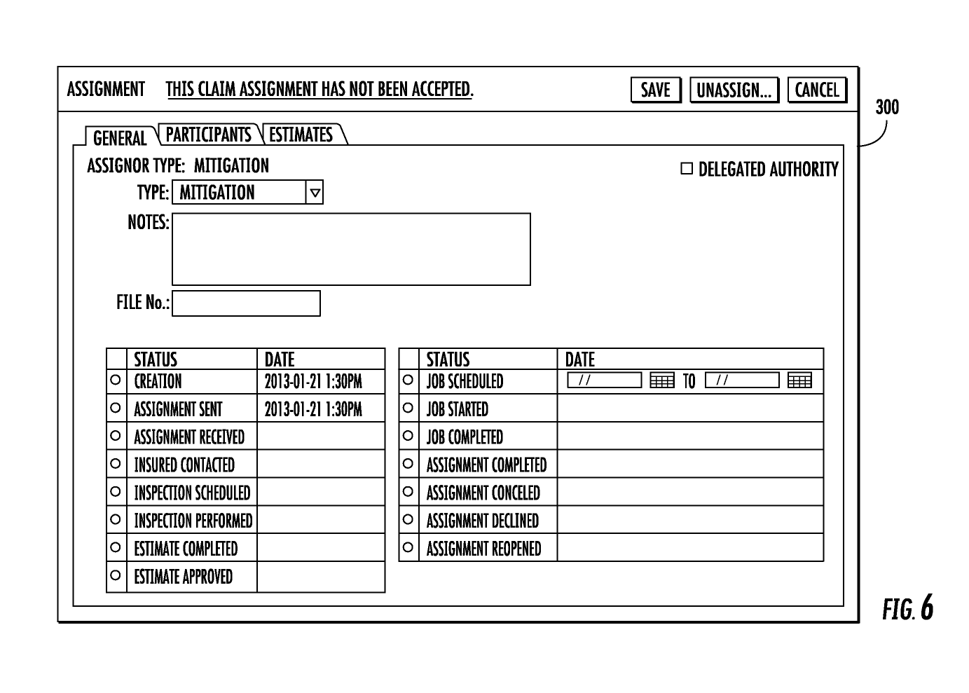

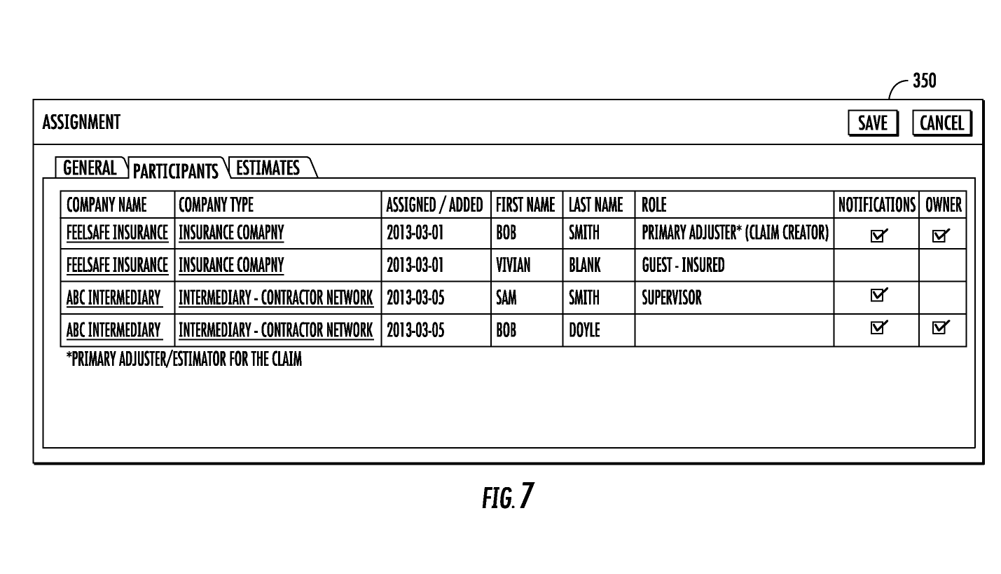

FIG. 6 is a diagram of an example screen display 300 presented on display 24 by task assignment module 46. In particular, FIG. 6 illustrates the “general tab” of the assignment page presented on screen display 300. In the example illustrated, if a user/participant or company does not have permission to change an assignment, each graphical user interface or selection is disabled. The “assignor type” row appears when viewing a sub-assignment—it shows the type of the assignment for the assignor. The “type” dropdown contains the list of assignment types of the assignor and is disabled for the assignee (or sub-assignee). The “notes” field is disabled when “type” is disabled. In the example illustrated, the “file no” row appears only if the company is not an insurance company and is editable by the assignee (or sub-assignee). The assignment status is editable by the assignee (or sub-assignee). In the example illustrated, only the statuses relevant to the assignment type are shown; however, if the current status of the assignment is a status that is hidden for the assignment type, the status is shown. In the example illustrated, the current status is in bold and the background of the row is selected. A user is able to select another status by clicking on the row (no need to click on specific radio button).

In one implementation, testify module 46 applies the following policies or rules for the assignment of tasks using display screen 300:
1. Both the assignee and the assignor can set an assignment to completed, cancelled and reopened
2. Setting an assignment to completed/cancelled does not affect parent nor child assignment statuses
3. Setting an assignment at cancelled delete (mark as deleted) all estimates linked to that assignment
4. If some statuses have been hidden for the assignment type, the rows are not shown
5. If viewing the “Originator” assignment, only the statuses appear in the General tab. The statuses that appear are the ones defined in the claim defaults.
6. All fields are disabled until the assignment is accepted
7. The un-assign button is only visible when the user has the right to un-assign:
   The originator “assignment” can never be un-assigned/removed
   If an assignment has sub-assignments, it can't be un-assigned until all sub-assignments are un-assigned (like currently)

In the example illustrated, Declining an assignment sets the assignment status to assignment declined and deletes (mark as deleted) all estimates linked to that assignment.

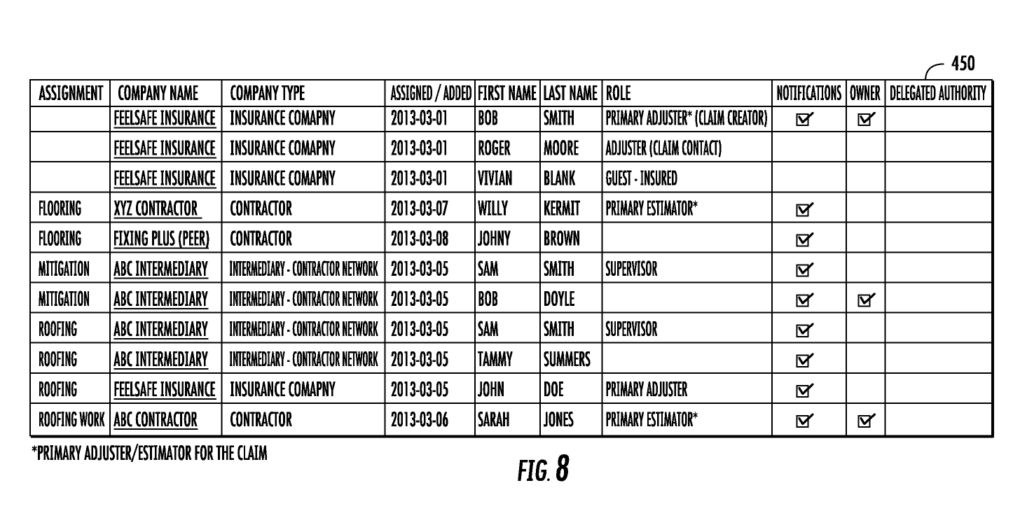

FIG. 7 illustrates an example screenshot or display screen 350 illustrating the “participants” tab of the assignment screen. As shown by FIG. 7, the participants tab lists all users that are part of an assignment. In the example illustrated, the company name, company type, the date that the assignment was created, the recipient of the assigned task and the role of the recipient of the assigned task identified. Display screen three and 50 further illustrates that additional information is provided such as whether the recipient of the assigned task is to receive notifications and whether the recipient is an owner of a component of the insurance claim 50. In other implementations, task assignment model 46 may convey such information or alternative information in a different fashion.

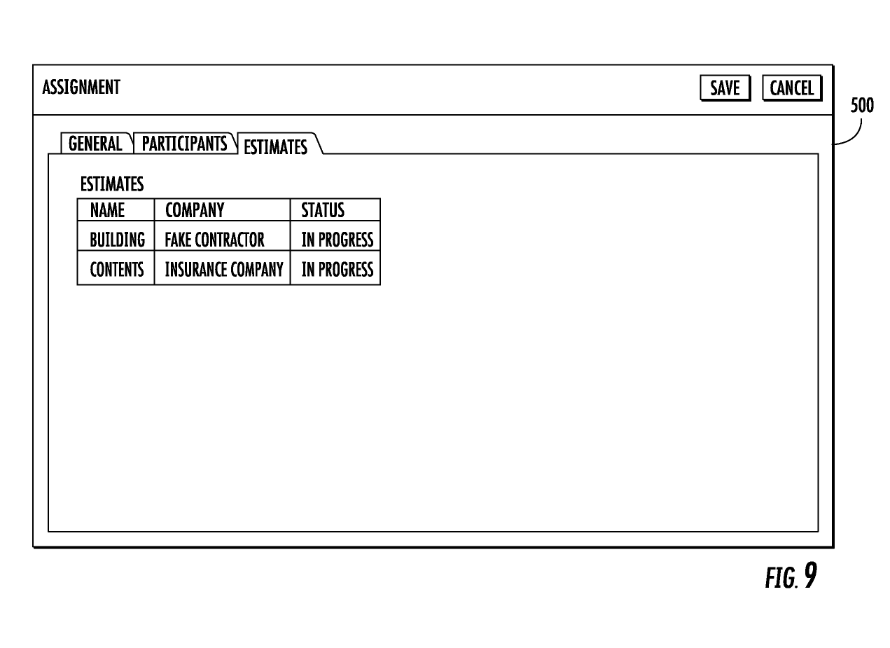

FIG. 8 illustrates another example of the participants tab. FIG. 8 illustrates display screen 450, part of the participants tab. As shown by FIG. 8, tab assignment module 46 supports multiple assignments. In the example illustrated, the list of participants is automatically sorted by assignment, then company name, then first name, then last name. The “assignment” column indicates the task being assigned. As shown by 8, task assignment module 46 facilitates assignment of the same task to different participants from the same vendor/company.

FIG. 9 illustrates display screen 500, illustrating an example of the “estimates” tab of the assignment page. As shown by FIG. 9, the estimates tab lists all estimates linked to the assignment. In the example illustrated, only the root estimates are listed, not supplements. Selecting or clicking on an estimate line opens the estimate in a new browser/tab window to present details of the estimate.

While the preferred embodiments of the invention have been illustrated and described, it will be appreciated that various changes can be made therein without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically and overtly defined in this specification, the terminology used in the present specification is intended to be interpreted in its broadest reasonable manner, even though may be used conjunction with the description of certain specific embodiments of the present invention.

What is claimed is:

1. An insurance claim handling system comprising:
a memory;
an insurance claim file stored in the memory, the insurance claim file comprising assignment of tasks to different participants;
an ownership designation for the insurance claim file stored in the memory;
a processor to concurrently provide different degrees of access to the insurance claim file to different participants based upon the stored ownership designation.

2. The insurance claim handling system of claim 1, wherein the insurance claim file comprises a first component and a second component and wherein the ownership designation designates ownership of the first component to a first participant and designation of a second component to a second participant, ownership of a component allowing a participant to modify the component.

3. The insurance claim handling system of claim 2, wherein the memory comprises an ownership management module comprising non-transitory computer-readable medium containing program logic to direct the processor to facilitate assignment of ownership of the first component, independent of the second component, by the first participant.

4. The insurance claim handling system of claim 2, wherein the memory comprises an ownership management module comprising non-transitory computer-readable medium containing program logic to direct the processor to prevent modification of the first component by any participant not designated as owning the first component.

5. The insurance claim handling system of claim 4, wherein the ownership management module contains program logic causing the processor to allow a participant not designated as owning the first component to make changes to a copy of the first component.

6. The insurance claim handling system of claim 5, wherein the ownership management module contains program logic causing the processor to allow the first participant to release the first component to a designated participant for purposes of making changes to the first component instead of making a copy.

7. The insurance claim handling system of claim 5, wherein the ownership management module contains program logic to display the copy of the first component and the first component, while visibly indicating commonality and/or differences between the copy of the first component and the first component.

8. The insurance claim handling system of claim 2, wherein the memory comprises an ownership management module comprising non-transitory computer-readable medium containing program logic to direct the processor to concurrently display ownership of the first component and the second component.

9. The insurance claim handling system of claim 2, wherein the insurance claim file comprises a loss summary page, the loss summary page automatically designated as being owned by any participant who owns at least one component of the insurance claim file.

10. The insurance claim handling system of claim 1, wherein the insurance claim file comprises different assignments of tasks to different participants from a single vendor.

11. The insurance claim handling system of claim 10, wherein, wherein the memory comprises a task assignment module comprising non-transitory computer-readable medium containing program logic to direct the processor to concurrently provides access to the insurance claim file to different vendors, allowing the different vendors to view assignments of tasks to other vendors.

12. The insurance claim handling system of claim 11, wherein the memory comprises a task assignment module comprising non-transitory computer-readable medium containing program logic to direct the processor to display some task assignments while hiding other task assignment based upon the task.

13. The insurance claim handling system of claim 11, wherein the memory comprises a task assignment module comprising non-transitory computer-readable medium containing program logic to receive a first assignment of a first task to a first assignee and to automatically generate and store in the memory a second assignment of the first task or one or more sub-tasks related to the first task to one or more second assignees in response to receipt of the first assignment of the first task to the first assignee.

14. An apparatus comprising:
a non-transitory computer-readable medium containing program logic to direct a processor to:
designate different components of an insurance claim file with different ownership, ownership of one of the different components allowing a participant to modify said one of the different components; and
concurrently modify the different components in response to input from different participants having designated ownership in the different components.

15. The insurance apparatus of claim 14, wherein the non-transitory computer-readable medium contains program logic to direct the processor to facilitate assignment of ownership of a first component of the insurance claim file, independent of a second component of the insurance claim file, by a participant designated as owning the first component.

16. The apparatus of claim 15, wherein the non-transitory computer-readable medium contains program logic to direct the processor to prevent modification of the first component by any participant not designated as owning the first component.

17. The apparatus of claim 16, wherein the non-transitory computer-readable medium contains program logic causing the processor to allow a participant not designated as owning the first component to make changes to a copy of the first component.

18. An apparatus comprising:
a non-transitory computer-readable medium containing program logic to direct a processor to:
receive, store and display a first assignment of a first task towards completion of an insurance claim file to a first participant of a first vendor; and
receive, store and display a second assignment of a second task towards completion of the insurance claim file to a second participant of the first vendor.

19. The apparatus of claim 18, wherein the non-transitory computer-readable medium contains program logic to direct the processor to display some task assignments while hiding other task assignment based upon the task.

20. The apparatus of claim 18, wherein the non-transitory computer-readable medium contains program logic to receive a first assignment of a first task to a first assignee and to automatically generate and store in the memory a second assignment of the first task or one or more sub-tasks related to the first task to one or more second assignees in response to receipt of the first assignment of the first task to the first assignee.
